(19) United States
(12) Patent Application Publication
(10) Pub. No.: US 2012/0278102 A1
(43) Pub. Date: Nov. 1, 2012

(54) Real-Time Automated Interpretation of Clinical Narratives

(75) Inventor: Peter Johnson, Milton Keynes (GB)

(73) Assignee: Clinithink Limited, London (GB)

(21) Appl. No.: 13/425,719

(22) Filed: Mar. 21, 2012

Related U.S. Application Data
(60) Provisional application No. 61/467,603, filed on Mar. 25, 2011.

(51) Int. Cl. G06Q 50/24

(52) U.S. Cl. 705/3

(57) ABSTRACT

Techniques for enabling real-time automated interpretation of clinical narratives are disclosed. The automated interpretation can be achieved by translating narrative text into a clinical terminology-encoded structural representation such as the Systemized Nomenclature of Medicine-Clinical Terms (SNOMED-CT) example of such a clinical terminology. The translation process enables the generation of both pre-coordinated and post-coordinated SNOMED CT concept expressions.

### CROSS-REFERENCE TO RELATED APPLICATION

This application claims priority to U.S. Provisional Application No. 61/467,603, filed Mar. 25, 2011, which is incorporated herein by reference for all purposes.

### BACKGROUND

Embodiments of this invention relate in general to natural language processing, and in particular to techniques for interpreting clinical narratives.

Clinicians delivering healthcare typically document progress, findings, plans, and decisions in the form of textual notes or reports (i.e., clinical narratives) in a patient record of some kind The language used to create these clinical narratives is rich, complex, and specialized. Clinical narratives are often described as semi-structured—neither random nor easily predictable. Very subtle changes in the word content of a clinical narrative can have a dramatic effect on meaning; for example, “evidence of malignancy was found” versus “no evidence of malignancy was found.”

The linguistic subtleties and complexity of clinical language make it difficult to meaningfully interpret clinical narratives in an automated manner. Conventional electronic health record (EHR) systems highlight this problem. Current EHR systems either (1) disallow entry of freeform narratives and require users to enter clinical information using a rigid, predetermined set of data entry fields, or (2) allow entry of freeform narratives but do not perform any processing or interpretation of the text. With approach (1), the rigid structure imposed on users at the time of data entry results in low compliance and lost information. With approach (2), there is no machine processing/understanding of the entered narratives, and thus the benefits that could be derived from aggregation, analysis, exchange, and decision support functions based on the content of the narratives are sacrificed.

### BRIEF SUMMARY

Embodiments of the present invention provide a technology platform (referred to herein as “CLiX”) for enabling real-time, automated interpretation of clinical narratives. In one set of embodiments, this interpretation can be achieved by translating narrative text into a clinical terminology-encoded structural representation. One example of such a clinical terminology is SNOMED CT (Systemized Nomenclature of Medicine-Clinical Terms), an emerging standard in healthcare IT. The technology described here enables the generation of both pre-coordinated and post-coordinated SNOMED CT concept expressions as will be discussed in detail below.

A further understanding of the nature and advantages of the embodiments disclosed herein can be realized by reference to the remaining portions of the specification and the attached drawings.

### BRIEF DESCRIPTION OF THE DRAWINGS

FIG. 1 is a block diagram of a logical architecture for the CLiX platform;

FIG. 2 is a flow diagram of a process for translating clinical narrative into a structural representation;

FIG. 3 is a flow diagram of an import process performed by the CLiX engine;

FIGS. 4-6 are flow diagrams of activities performed during a matching phase by the CLiX engine;

FIGS. 7-9 are flow diagrams of activities performed during a post-coordination phase by the CLiX engine;

FIG. 10 is a flow diagram of an output process performed by the CLiX engine;

FIGS. 11-25 are screenshots of example client user interfaces;

FIG. 26 is a block diagram of a system environment; and

FIG. 27 is a block diagram of a computer system.

### DETAILED DESCRIPTION

In this description, specific details are provided to enable an understanding of embodiments of the invention, however, it will be apparent that various embodiments of the invention can be practiced without these specific details. Embodiments of the invention provide a technology platform (referred to herein as “CLiX”) for enabling real-time, automated interpretation of clinical narratives. In one set of embodiments, this interpretation is achieved by translating narrative text into a clinical terminology structural representation. One example of such a clinical terminology is the Systemized Nomenclature of Medicine-Clinical Terms, commonly known as SNOMED CT. SNOMED CT is an emerging standard in healthcare information technology. Our system enables the generation of both pre-coordinated and post-coordinated SNOMED CT concept expressions.

### 1. Overview of SNOMED CT

SNOMED CT is a systematically organized, computer processable collection of clinical healthcare terminology that includes many areas of clinical information, e.g. findings, procedures, body structures, pharmaceutical products, and the like. SNOMED CT defines clinical “concepts,” where each concept is represented by a unique series of digits known as a ConceptID. An example of a ConceptID is “Myocardial Infarction.” In SNOMED CT this is represented by ConceptID 22298006. Each concept can be associated with “descriptions,” which are terms or names assigned to the concept. The descriptions include a “preferred term,” usually the most common term used by clinicians to describe the concept, as well as synonyms”—alternative terms used to describe the same concept. For example, the concept “myocardial Infarction” is associated with the preferred term “Myocardial Infarction” as well as synonyms “cardiac infarction,” “heart attack,” and “infarction of heart.”

Clinical concepts that directly map to a ConceptID in SNOMED CT (such as “Myocardial Infarction” above) are referred to as pre-coordinated concepts. The current version of SNOMED CT defines approximately 345,000 pre-coordinated concepts. This provides a rich terminology for describing clinical conditions and situations. SNOMED CT, however, also enables description of more complex clinical expressions by using a mechanism known as “post-coordination.” Post-coordination allows pre-coordinated concepts to be combined according to a description logic, thereby resulting in the definition of new concepts.

SNOMED CT concepts are representational units that categorize all the things that characterize health care processes and need to be recorded therein. All SNOMED CT concepts are organized into acyclic taxonomic (is-a) hierarchies; for example, Viral pneumonia IS-A Infectious pneumonia IS-A Pneumonia IS-A Lung disease. Concepts may have multiple parents, for example Infectious pneumonia is also a child of Infectious disease. The taxonomic structure allows data to be recorded and later accessed at different levels of aggregation. SNOMED CT concepts are linked by approximately 1,360,000 links, called relationships.

SNOMED CT concepts are further described by various clinical terms or phrases, called Descriptions, which are divided into Fully Specified Names (FSNs), Preferred Terms (PTs), and Synonyms. Each concept has exactly one FSN, which is unique across all of SNOMED CT. In addition each concept has exactly one Preferred Term, which has been decided by a group of clinicians to be the most common way of expressing the meaning of the concept. A concept may have zero to many Synonyms. Synonyms are additional terms and phrases used to refer to this concept. They do not have to be unique or unambiguous.

Consider the clinical statement “fractured left neck of femur,” which does not directly map to a pre-coordinated concept in SNOMED CT. This statement can nevertheless be captured by refining a clinical finding of “fracture” with a finding site of “neck of femur,” and further qualifying the finding site with a laterality of “left.” The ability to refine, qualify, and modify clinical concepts via post-coordination makes the SNOMED CT terminology powerful and unique. Older traditional terminologies generally support a limited range of concepts which cannot be qualified or refined. The fact that concepts in the SNOMED CT terminology can be combined and modified to create essentially new concepts enables a near limitless number of clinical statements to be represented.

SNOMED CT also supports other relationship types between concepts. For example, “is a type of” enables different concepts to be related at different levels of specificity. A “leg oedema” can be represented as a type of “oedema” within the terminology. This mechanism enables equivalence to be evaluated between different concepts regardless of where they are actually defined within the terminology—a problem with traditional terminologies. For instance, two clinical findings can be related to a particular body site and thus, while they are not classified into the same disease/clinical finding category, they can be evaluated as findings related to the body site in question.

Additional information regarding SNOMED CT can be found in “SNOMED Clinical Terms User Guide 2010,” published by the International Health Terminology Standards Development Organization (IHTSDO), and is available through their website.

### 2. Logical Architecture

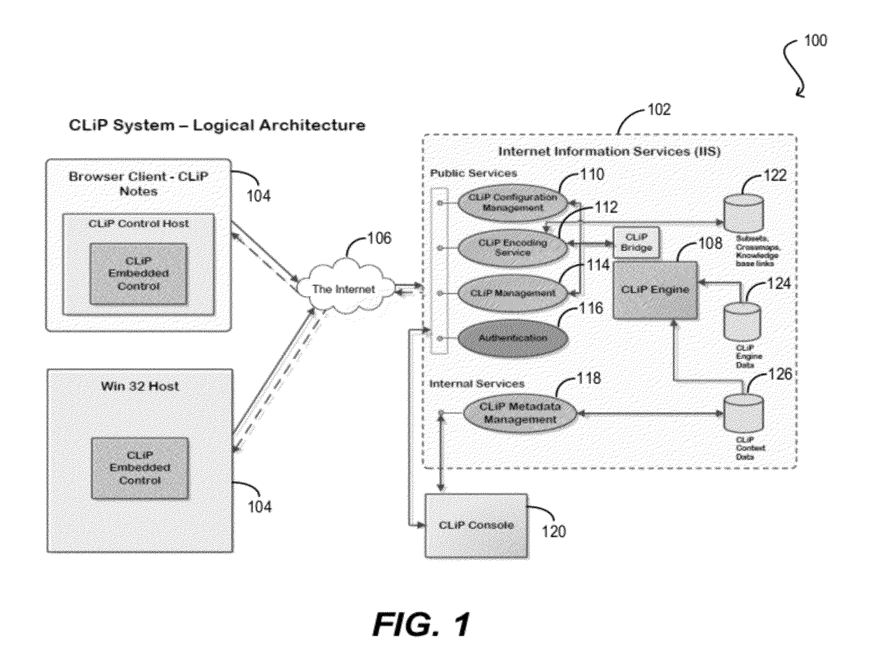

FIG. 1 is a block diagram of a logical architecture 100 for the CLiX platform in one embodiment of this invention. Architecture 100 includes a server 102 and clients 104 that are communicatively coupled via a network 106. Although only one server and two clients are depicted, any number of such servers and clients can be supported.

Server instance 102 includes the CLiX engine 108, services 110-118, and data stores 122-126. CLiX engine 108 acts as the central processing component of the CLiX platform and is configured to receive clinical narrative text as input from, for example, clients 104. The server translates, in real-time, the input narrative into an encoded structural representation such as SNOMED CT, which is provided as the encoded output. The specific processing performed by CLiX engine 108 is described in greater detail in Section 3 below.

CLiX engine 108 can be implemented in software, hardware, or a combination thereof. In the preferred embodiment, CLiX engine 108 is implemented as a C++ library with associated engine data files. As described below, the data files preferably are derived from the latest SNOMED CT release and proprietary metadata.

Services 110-118 represent interfaces that allow consuming entities, such as clients 104, to access the translation functions provided by CLiX engine 108. Services 110-118 can also provide additional features such as hierarchical structuring of encoded output, cross-mapping to other coding systems (ICD10, OPCS4.5, etc.), knowledge base links, platform configuration, metadata management via local console 120, authentication, etc. In one set of embodiments, server instance 102 is a web server application, such as Microsoft Internet Information Services (IIS) or Apache. In these embodiments, services 110-118 are implemented as standards-compliant XML web services. This allows for rapid and cost-effective integration of the CLiX technology into the infrastructure of customer environments.

In one implementation, data stores 122-126 store various types of data including SNOMED CT data, proprietary metadata, CLiX engine data files, cross-mappings to other terminologies, and knowledge base links that are used by CLiX engine 108 or services 110-118. Additional details regarding the data in data stores 122-126 is provided below in Section 3.

Clients 104 act as the front-end to the CLiX platform and include, inter alia, a user interface for receiving clinical narratives from end-users, a mechanism for transmitting the clinical narratives to CLiX engine 108 through services 110-118, and a user interface for displaying the encoded representations in either a graphical or textual format output by engine 108. In one set of embodiments, clients 104 are implemented as standalone clients program, such as a Win32 application. In other embodiments, clients 104 are implemented as a plug-in to a web browser. Network 106 can by any type of network that enables data communication, such as a local area network, a wide area network, a virtual network, or the Internet, or even a collection of interconnected networks.

FIG. 1 is illustrative and not intended to limit embodiments of the present invention. For example, architecture 100 can include more or fewer components than those depicted in FIG. 1. One of ordinary skill in the art will recognize variations, modifications, and alternatives.

### 3. CLiX Engine

As described above, CLiX engine 108 of FIG. 1 acts as the main processing component of the CLiX platform and is responsible for translating plain, unformatted clinical narrative text into a terminology-encoded structural representation. For illustration, the following sections describe processing performed by the CLiX engine for encoding SNOMED CT-based expressions. The techniques described here, however, are equally applicable to other clinical terminologies.

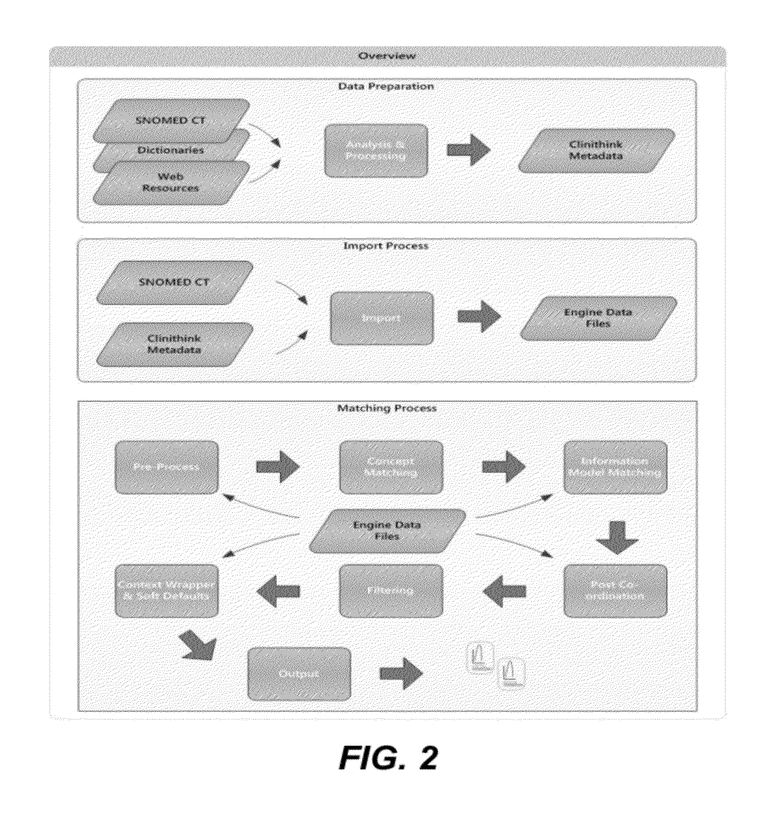

The overall approach used by the CLiX engine is illustrated in FIG. 2 and is divided into three high level processes/areas:

Data preparation;

Import of data; and

Matching of narrative.

The data preparation process is typically a long-running, iterative phase that involves analyzing, processing and optimizing various data resources to generate data/metadata for use by the CLiX engine. This data/metadata can be modified and extended over time to accommodate further data resources, enabling continual improvements to be made to the operation of the CLiX engine.

The import process occurs prior to the CLiX engine being deployed for use, and involves generating data files based on the data/metadata collected during the data preparation phase. The data files produced during the import process are packaged alongside the CLiX engine binaries, which are then installed/configured by end users. The import process can be repeated periodically when key datasets such as the SNOMED CT datasets are updated. The resulting data files can be distributed to users to update their CLiX installations.

The matching process represents the core operations performed by the CLiX engine at runtime to transform clinical text into an encoded representation.

### 3.1 Data Preparation Process

In various embodiments, the data preparation process involves collecting and processing two types of data used by the CLiX engine: SNOMED CT data and proprietary metadata.

### 3.1.1 SNOMED CT Data

The SNOMED CT content is data produced by IHTSDO and its affiliated organizations. They are responsible for the authoring and maintenance of SNOMED CT content. The affiliated organizations produce language translations of the official IHTSDO data release, as well as additional extension data which deals with specific local/regional variations. For example, a UK affiliate produces an extension to the SNOMED CT core content which includes UK-specific medication information, as well as other data.

During the data preparation process, the SNOMED CT data can be subjected to a analytical processes alongside other sources of data so that the resulting statistical patterns are skewed toward clinical data. The elements of SNOMED CT data that are typically utilized are:

IHTSDO core release;

UK extension;

UK drugs extension;

US drugs data; and

Machine Readable Concept Model (MRCM).

Of course other extensions such as Australian Medicine Terminology can also be utilized.

The IHTSDO core release is the primary release of SNOMED CT data from IHTSDO and includes concepts, descriptors, relations, subsets and cross-maps. The IHTSDO data is distributed as a set of structured text files which can be processed into machine readable structures such as databases. The concepts element of the SNOMED core represents the full set of concepts supported by SNOMED CT. The descriptors element represents all of the potential descriptions for each of the core concepts. Similarly, the relations element represents all of the relationships among concepts.

The IHTSDO core data includes subset definitions which are group together sets of concepts for a desired purposes. For example, a subset can be created to represent all of the concepts used to define the smoking status of an individual. These subsets are described by the list of concepts included within the subset.

The cross-map data provides the mechanism through which a SNOMED CT concept can be mapped, that is translated, into another terminology. The data includes both the mappings themselves and certain rules that describe legitimate scenarios in which the cross-mapping may be used. For example the SNOMED CT concept Asthma with Concept ID 195967001 can be mapped directly to the term Asthma, unspecified type with code 493.90 in the ICD9-CM terminology. Where a SNOMED CT concept maps or corresponds to more than one term in an alternative terminology, rules may specify further within which circumstances the mapping is allowed or provide ranking information for which mapping is preferred.

As suggested above, SNOMED CT extensions are known. The UK extension of SNOMED CT is published by the UK IHTSDO affiliate and includes UK specific extensions to the SNOMED CT core data. SNOMED CT extensions are a mechanism through which additional concepts, descriptors, relationships, cross-maps and subsets can be defined. For example, the UK Drug extension includes all of the concepts, descriptors and relationships required to represent UK specific medicines, ingredients and packages. The UK extension elements used include concepts, descriptors, relations, subsets and cross-maps. In a similar fashion to the UK extension, there is a US drugs extension which incorporates the concepts, descriptions and relationships required to represent US drug information.

The final element of SNOMED CT data is the Machine Readable Concept Model (MRCM). The MRCM is a machine readable representation of constraints that apply to post-coordinated SNOMED CT expressions. These constraints effectively describe the allowable compositions of sets of SNOMED CT concepts to make more specific expressions.

### 3.1.2 Proprietary Metadata

The proprietary metadata is content that is created and maintained specifically to support the algorithms performed by the CLiX engine. This data can be created manually or by analyzing various sources of data with specific tools. Exemplary data that can be included are:
Part-Of-Speech (POS) tagger word list and probabilities;
Lemmatization dictionary;
Synonymous words and phrases;
Abbreviation dictionary;
Acronym dictionary;
Phrase replacement tables;
Synonymous phrases for concepts;
Canonical contexts table;
Heading to Canonical Context Mapping;
User vocabulary and phrase tables;
Soft defaults for post-coordination;
Subsets for exclusion of terms and concepts;
Subsets for categorization of concepts; and
Lists of contextually high and low relevance words.

The Part-of-Speech (POS) word list and probabilities are used by a “POS tagger” during the matching process to identify the part of speech for a particular word in a sentence or context. The normal approach for creating such a lexicon is to manually mark or tag words in a given text (corpus) with labels for a particular part of speech (noun, verb etc.) based on the definition of the word and the context in which it is located.

In some embodiments, this word list is generated iteratively. First, an initial word list and part of speech tags are obtained by using pre-tagged corpora identified by other publicly available POS taggers. This initial dataset can then be refined using the CLiX engine POS tagger and the word list to attempt to POS tag SNOMED CT content. Any SNOMED CT content that cannot be tagged in this manner is then manually tagged and the process repeated. As new clinical words are encountered, they can be manually added during maintenance of the tagger.

The lemmatization dictionary is a dataset of base words, i.e. lemmas, and their various inflected forms. This dictionary is accessed during the matching process to identify the base forms of words in input text so that the text can be analyzed in a consistent fashion. For example, in English, the verb “to speak” may appear as “speak,” “spoke,” “speaks,” “speaking” The base form, or lemma, for the word that would be used in the dictionary in this case is “speak.”

In one embodiment, the lemmatization dictionary is created by taking a set of public domain dictionaries to collect words and merge these with words from SNOMED CT to create a base dictionary without lemmas. A combination of algorithmic lemmatization and a manual editing process then populates the dictionary with the corresponding lemmas for each word.

The synonymous words and phrases mapping table provides a list of words which are treated as equivalent to one another. The SNOMED CT data provides alternate words and phrases. This table provides additional content to supplement the SNOMED CT data. For example, in the table the words “medicine,” “medication” and “drug” can be listed as alternatives for one another.

The abbreviation dictionary identifies abbreviations that are common in clinical contexts and their corresponding expansions. In one embodiment, this dictionary is manually created by trawling medical websites, medical texts and SNOMED CT content. The abbreviations included in the dictionary can incorporate additional context data, including language, to enable disambiguation of abbreviations in different contexts.

The acronym dictionary identifies acronyms common in clinical contexts and their corresponding expansions. Like the abbreviation dictionary, the acronym dictionary can be manually created by trawling medical websites, known acronym lists and SNOMED CT content. In a particular embodiment, the acronyms included in the dictionary incorporate additional context data, including language, to enable disambiguation of acronyms in different contexts.

The phrase replacement tables are used during the matching process for phrase avoidance and to replace phrases with synonymous phrases that encode successfully. For example the phrase “lower lid” can be listed in the phrase replacement table for replacement by “lower eyelid.” If desired, a use context can be stored against some of the entries in the phrase replacement tables. This allows the appropriate phrase replacement to be made when a particular context is applied to the input text. Phrase replacement can be used where a phrase does not directly map to a SNOMED CT concept, but might be part of the description of multiple SNOMED CT concepts.

The synonymous phrases tables have a similar purpose to the phrase replacement tables, except that the synonymous phrases can directly map to a SNOMED CT concept. In effect, the synonymous phrases tables provide a mechanism for extending the SNOMED CT descriptions table independently of the table itself. They also enable synonymous phrases to change depending on context. For example, in the synonymous phrases tables the phrase “chest nad” can be mapped directly to the SNOMED CT concept “275736000 O/E—chest examination normal.” Some synonymous phrases have a different meaning in differing contexts. In these cases, the synonymous phrases tables can provide a mechanism for specifying the allowable context for the mapping.

The canonical contexts table contains details of different clinical contexts (e.g., Chief Complaint, Review of Systems etc.) within which clinical text may be found. There can be variations of these contexts. For example, “Presenting Complaint” and “Chief Complaint” have identical meanings, enabling the canonical contexts table to provide a definitive list to which other variations can be mapped. The heading to the canonical context mapping table provides a many-to-one mapping of the variety of headings one might expect to find in clinical text to the corresponding canonical context.

The user vocabulary and phrase tables can be present for each kind of post-coordination relationship. This provides up to 4 tables for each type of post-coordination (e.g., modification, qualification, refinement) and documents the phrases and appropriate SNOMED CT concept that may occur in specific circumstances related to the post-coordination expression. In one set of embodiments, the tables cover phrases that may occur before the target, after the target, phrases to avoid, and limit phrases.

For example in the case of laterality, the table representing phrases that are acceptable before the target might include the phrase “left sided” to denote that phrase is allowed to appear before the “femoral fracture” to enable the laterality left to be applied to the “femoral fracture” concept. This same phrase, however, might not exist in the table representing acceptable phrases after the target. This is because the text “femoral fracture left sided” is very unlikely to be found in narrative text. Equally the phrase “has been left” might appear in the phrases to avoid table as something that is unlikely to represent the intention to specify laterality against the target.

The soft defaults data file provides a mapping of the concepts that should be included by default in a post-coordinated SNOMED CT expression in various clinical contexts as specified by the Canonical Contexts data. For example, if a statement is entered under a “plan” context, procedures can have a soft default applied to the procedure context of “planned.”

The subsets for exclusion of terms and concepts specifically excludes certain terms and/or concepts from being recognized where terms in SNOMED CT do not contain explicit context. This prevents inappropriate concept selection. For example, the term “6 meters” is defined as being a vision test distance, but if used alone it might be used in the wrong context.

Subsets for categorization are used to control matching of concepts that are appropriate for certain kinds of record heading, such as “Allergies.”

The lists of high or low relevance words in contexts are used during the matching process to alter the scoring of the most relevant matched concept depending on clinical context.

### 3.2 Import Process

After the data preparation process described above, the collected datasets are imported by the import process into memory-mapped data structures or files. These data structures and files are used by the CLiX engine at runtime to facilitate the matching process. The data structures and files can be optimized to reduce storage costs, provide more rapid performance and improve matching capabilities. The import process can be considered as two logical operations—import of the metadata and import of the SNOMED CT core data and extensions.

### 3.2.1 Import of Metadata

During this import operation, metadata gathered during the data preparation process is read from source disk files, manipulated to remove redundant data and to generally optimize its structure for later processing. Once the manipulation is complete, the metadata is stored in memory-mapped data files which are also stored on the local disk for re-use. Each time the CLiX engine initializes, for example, after a system reboot, these files are read into memory for use during the matching process by the engine.

While the order of importation is arbitrary (except that the metadata is preferably imported before the SNOMED CT data), in the preferred embodiment the source files are imported in the following order:
Alternate word/phrases
Lemmatization dictionary
POS tagger lexicon
POS tagger matrix
Abbreviation lookup
Acronym lookup
Phrase replacement lookup
Synonymous phrase lookups
Post-coordination phrase tables
Canonical contexts
Heading maps
Soft defaults for post-coordination
Subsets for exclusion of terms and concepts
Subsets for categorization of concepts
Lists of contextually high and low relevance words

Once the importation is complete, the resulting data files are stored and packaged for shipping along with the CLiX engine. This process is typically performed for each supported processor/operating system combination.

### 3.2.2 Import of SNOMED CT Data

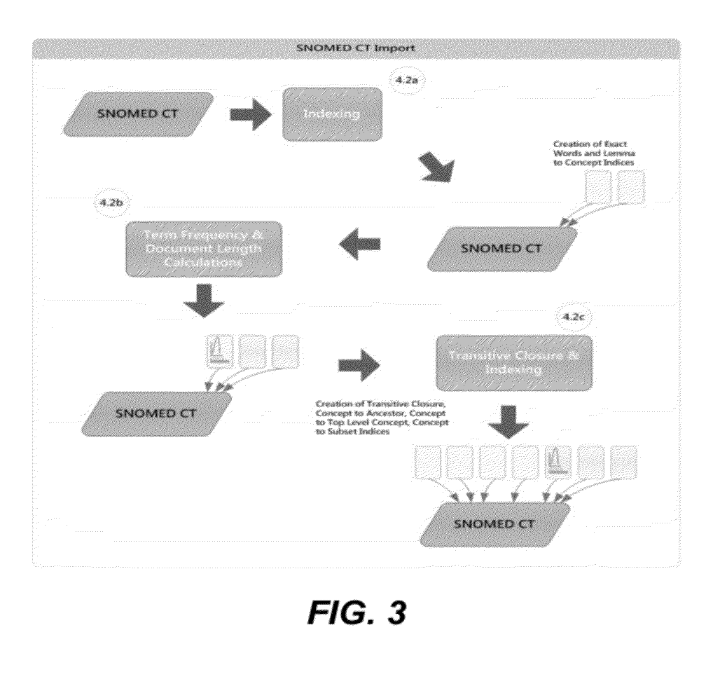

The import of SNOMED CT data includes the steps depicted in FIG. 3. The first step (labeled 4.2a) is to create a pair of inverted indexes that are stored against the SNOMED CT data. The inverted indices store a pointer for each individual word or token against the SNOMED CT concept within which it appears. This mechanism facilitates faster identification of the SNOMED CT concepts to match words in the input narrative.

The first index is an index of exact words that would be produced following tokenization or normalization processes. These processes are described in further detail below, but in essence they divide a clinical narrative string into individual tokens (e.g., words, punctuation symbols, etc.). This is performed as part of the pre-processing that occurs during the matching process. To facilitate faster lookups, the rules governing tokenization or normalization are applied to the SNOMED CT content during the creation of this first index. Thus the first index directly reflect how the data will be presented during the matching process. The second index is an index of lemma to SNOMED CT concepts.

At step 4.2b the frequency of occurrence for each term in the SNOMED CT release, as well as the length of the SNOMED CT concepts, are calculated. The pre-calculation of this data enables faster calculation of similarity scores, which are used during the matching process to determine the similarity of narrative terms with terms from the SNOMED CT release.

At step 4.2c a transitive closure matrix of the SNOMED CT concept graph is created. In essence during this operation, for every relationship defined in the SNOMED CT data, a value is calculated which defines whether a concept has a relationship with any other concept. The use of a transitive closure matrix provides a quick mechanism for determining whether any concept is effectively related to another concept. Additionally, during this step an index of concepts to top level concepts is calculated using standard graph traversal techniques. Step 4.2c can also include creating an index of SNOMED CT concept to subsets. This effectively provides the ability to quickly determine of which subsets a concept is a member.

### 3.3 Matching Process

The matching process is a central purpose of the CLiX engine. It is the core process which extracts clinical meaning from raw clinical narrative text. The process can be logically considered as having three discrete phases: (1) a matching phase, (2) a post-coordination phase, and (3) and output phase. These phases are considered in order below.

### 3.3.1 Matching Phase

The matching phase itself can be considered as having three activities. The first activity pre-processes the input text and standardizes it for presentation to the CLiX engine. The second activity performs matching of input tokens to SNOMED CT concepts. The third activity performs information model matching.

### 3.3.1.1 Pre-Processing Input Text

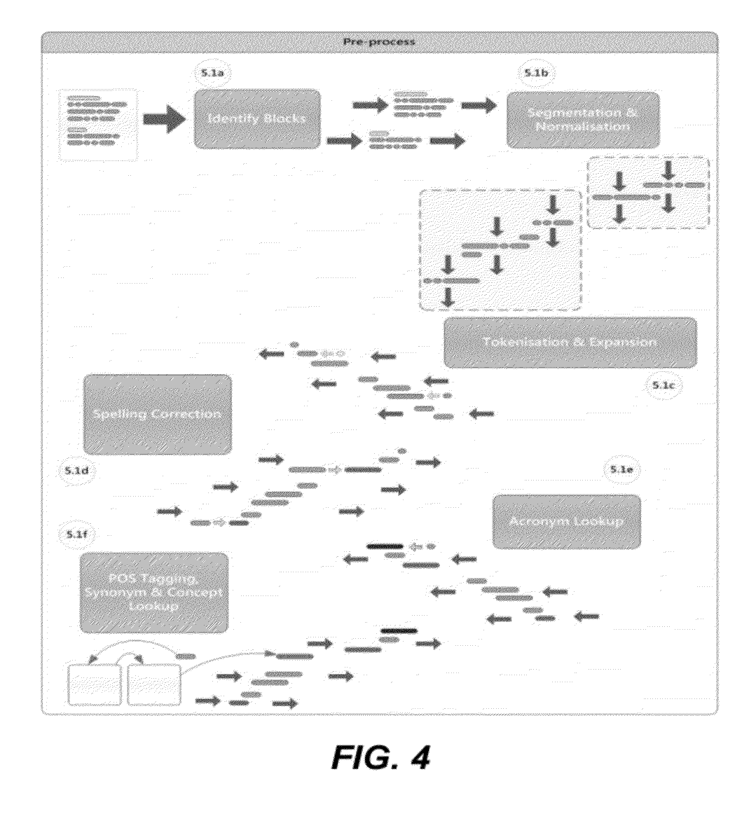

A sample flow for pre-processing the input clinical narrative is depicted in FIG. 4. The first step 5.1a of this activity is identifying individual blocks of text based on the identification of specific patterns of text representing headings. Searching for subsequent instances of the text patterns or specific configurable separator sequences enables the identification of the end boundary for the block. In the preferred embodiment this could be implemented by specifying the relevant heading text in a metadata configuration file containing phrases like “Chief Complaint” or “Medications” etc. The surrounding text features for these items, for example punctuation, line endings, paragraph endings would then be embedded with each instance of these phrases into in regular expressions.

Once the block boundaries have been identified, each block is processed separately at step 5.1b by breaking the block into segments. The individual segments can represent sentences or grammatical sequences that are considered to be logically separate. Further, each segment can be normalized so that it reflects an appropriate character set. For example, this results in control characters or extended characters such as accented characters being transformed into alternative equivalents.

In the preferred embodiment segmentation is achieved by scanning the input text until sequences representing segment start and end characters are identified. Normalization is achieved by converting the character set to the normal Latin set using a substitution matrix. Of course other approaches can also be used.

At step 5.1c once segments have been identified and normalized, each segment is broken into individual tokens, where each token approximates to an individual word or punctuation sequence. Generally speaking, each token approximates to one word. In addition, some specific sequences of characters common in clinical language are considered separate tokens by the CLiX engine, for example, “Q. 4 h” representing the phrase four hourly could be split into two tokens “q” and “4 h” or “p.r.n.” would become a single token “prn”.

In addition to tokenization, step 5.1c includes expanding contractions and abbreviations to their full forms. For example, “can't” is expanded to “can not.” Typical rules used by the CLiX engine to perform tokenization and expansion are derived from statistical analysis of volumes of medical text.

At step 5.1d, the CLiX engine performs spelling correction on the tokenized input. The spelling correction algorithm includes, inter alia, determining candidate replacements for an input token and calculating the edit distance between each candidate and the token. The distance can be calculated using the Damerau-Levenshtein algorithm. In addition, a “sounds like” conversion of the input token is calculated using the Caverphone phonetic matching algorithm or other suitable algorithm. In this manner candidate replacements can be determined and the edit distance calculated.

Once candidate replacements and their edit distances from the input token are determined, word frequencies and other empirical rules are used to choose the most likely correction. For example, a replacement is more likely to be the right one if the start and end characters are the same as the unknown word. If no suitable matches are identified, the input token is divided into two or three discrete words, each of which is analyzed using the algorithm described above. This enables the engine to address circumstances where words in the input narrative which are joined together without spaces, for example, by being typed incorrectly.

After spelling correction is complete, a lookup is performed against the acronym table and replacements processed using rules governing auto replacement, language, subset and context filtering (step 5.1e). As part of this step, phrase replacement is also performed using the phrase replacement table. In a particular embodiment, phrase replacements only occur if subset and context filters are passed.

At step 5.1f, the POS Tagger dictionary/matrix is used to lookup each token and to identify the most likely POS tag for words. This identification is based the frequency of occurrence of the tag or word combination and uses a statistical approach. At this time the CLiX engine also attempts to match input phrases to the data in the synonymous phrases tables and thereby identify a SNOMED concept corresponding to an input phrase.

### 3.3.1.2 Concept Matching

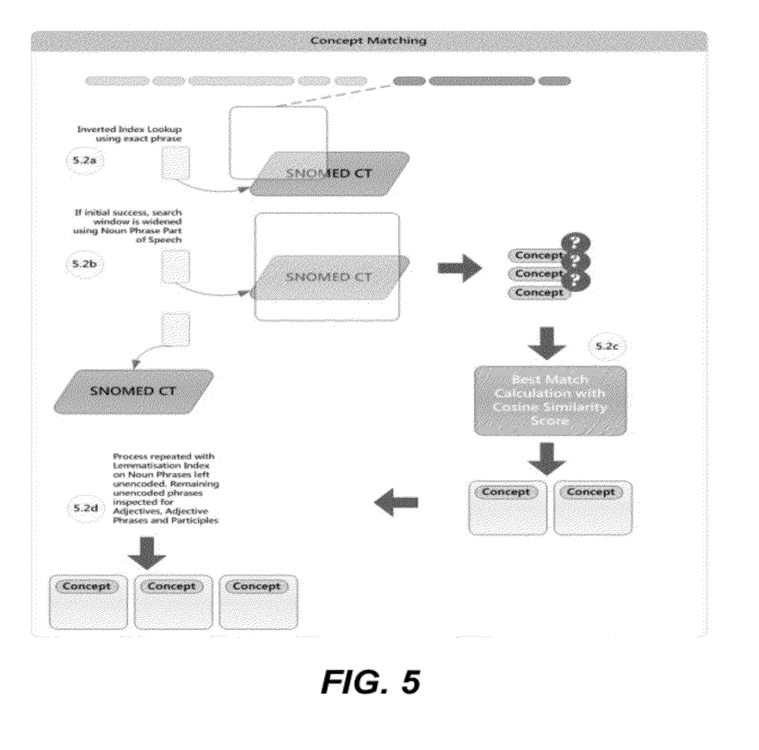

Once pre-processing is complete, concept matching begins. FIG. 5 illustrates an example flow for the concept matching activity. First, for each phrase in the input text, a search window is defined based on each noun in the phrase. This search window represents the sequence of tokens to try to match against the SNOMED CT data. Within the search window, an exact word match is attempted using the inverted index created during the import process (step 5.2a). This lookup is performed on a collection of words basis so that word order is irrelevant.

If the initial match is successful, the search window is expanded to include additional tokens that represent a legitimate noun phrase (step 5.2b). In other words, the input tokens which represent Part of Speech tags that could legitimately sit within the noun phrase are added to the search window. This process is repeated, adding more tokens into the search window until a failure to match is encountered. Once the failure point is reached, a retry of the search process is performed, but with specific words that may be post-coordinated excluded from the search. If the match still fails, the process takes the next position and retries.

Once the widest possible successful search window has been identified, the best match to SNOMED CT that passes filtering is selected. In various embodiments, filtering is based on language, dialect, subsets, top level concepts or other attributes related to the SNOMED CT data. These filters are selected by the end-user and included in a request for processing by the engine, i.e. a query to the CLiX engine. As part of each query to the engine a structure representing the mode of operation is provided with the request. This structure contains the details of each of the filtering options that a user of the engine would like applied. In addition specific calls to the engine can be made to retrieve lists of allowable values for each filter category.

In the preferred embodiment, the best match is determined by calculating a similarity score between the search phrase and each identified SNOMED CT term, together with a bias towards sets of words considered of high significance or low significance in particular contexts (step 5.2c). Preferably the similarity score is a cosine similarity score. Matches that have a score above a configurable threshold level, which was provided as part of the initial request, are considered to be successful matches. In different use cases, different threshold values may be used to provide different levels of control over the resulting output. This threshold value is provided as part of the “mode of operation structure” within each request. are used. For example, in a case where the context of the data is known to relate to medication, increasing the threshold can reduce the number of false positive matches. This reduces the amount of data to search to include only applicable subsets or top level concepts.

After completion of the noun phrase search, any noun phrases that are left unencoded can be evaluated to find their lemma values using the lemmatization dictionary. The search process is repeated using the lemmatization version of the index (step 5.2d). Any new or better matches identified within the lemmatization version of the search are then added to or used to replace the existing encodings. In addition, any unencoded phrases are inspected for matches with adjectives in SNOMED CT (e.g. “lethargic”) or adjective phrases (“very lethargic”), and for matches with verb participles (e.g. “vomiting”) and phrases with verb participles (e.g. “severe vomiting”).

### 3.3.1.3 Information Model Matching

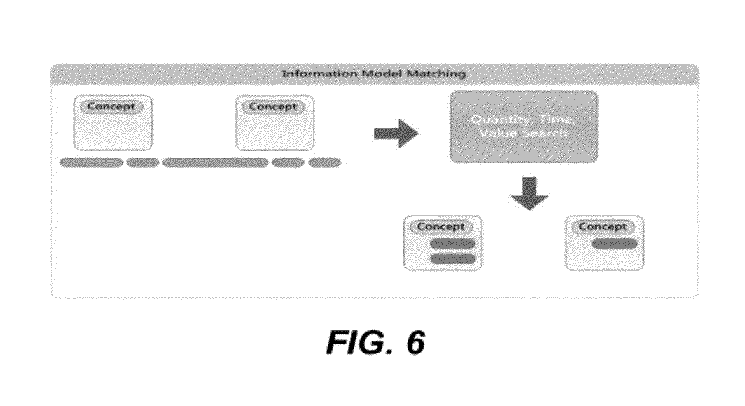

Once concept matching is complete, the remaining text in the input string is reviewed to identify any elements that may be representable by an information model, instead of the SNOMED CT terminology model. For example, a time duration value is not directly representable in a SNOMED CT expression, but the information model within which a SNOMED CT expression is subsequently stored may provide for storage of duration information. A representation of this information model matching activity is depicted in FIG. 6.

The types of information that may be present in the input string, but not represented in the encoded data include quantities, time or value information. Because the Part of Speech tagging will have already identified tokens which are numeric values or sequences, the CLiX engine can identify which tokens have not already been used in an encoded item. The “left over” tokens are evaluated against parsing rules to identify whether they represent a numeric value, for example, units, date or time value. Additionally, the input string is inspected for a small number of specific tokens that indicate the numeric sequence is related to age. Once these token sequences have been fully resolved, the data is stored with the concepts to which the data applies, enabling subsequent usage or output.

### 3.3.2 Post-Coordination

The post-coordination process is the process by which the CLiX engine generates post-coordinated SNOMED CT expressions. As described above, a post-coordinated expression is one in which a series of SNOMED CT concepts are combined according to documented SNOMED CT constraints (i.e., a description logic) to form an expression with a single meaning In general there are four types of post-coordination supported by the CLiX engine: qualification, modification, refinement, and assembly of individual concepts to make new ones.

Post-coordination through qualification refers to the process of selecting an appropriate qualifier from the various sets used to qualify the meaning of a concept. Consider the SNOMED CT concept for “dry cough” as an example. In its default form it has a qualifier for clinical course that states any allowable severity value is allowed. One could qualify this expression to specify a severity of “mild” which would qualify the default meaning of “dry cough” to “mild dry cough” There are a number of qualifiers available in SNOMED CT covering situations like severity, certainty, clinical course, and the like.

Post-coordination by modification is similar, but fundamentally changes the meaning of the concept. For example, post-coordination of the concepts “person in the family” and “asthma” implies a family history of asthma, rather than the patient having asthma.

Post-coordination through refinement is a situation in which a particular element of the definition of a concept is refined to have a more specific meaning. Taking the SNOMED CT concept for “hand pain” as an example, refining this expression makes the finding site more explicit. In this case, the narrative could specify the thumb structure of the left hand as the specific finding site.

Post coordination by assembly of different concepts occurs when two or more concepts are assembled according to the constraints of the Machine Readable Concept Model (MRCM) to make a new concept—e.g. when the concepts “erythema,” “skin of knee,” and “left” are assembled to make a new clinical finding concept meaning “Erythma of left knee.”

The CLiX implementation of post-coordination follows four discrete activities that include initial post-coordination, filtering, post-coordination of the context wrapper, and soft default post-coordination. Each activity is described in the sections that follow.

### 3.3.2.1 Initial Post-Coordination

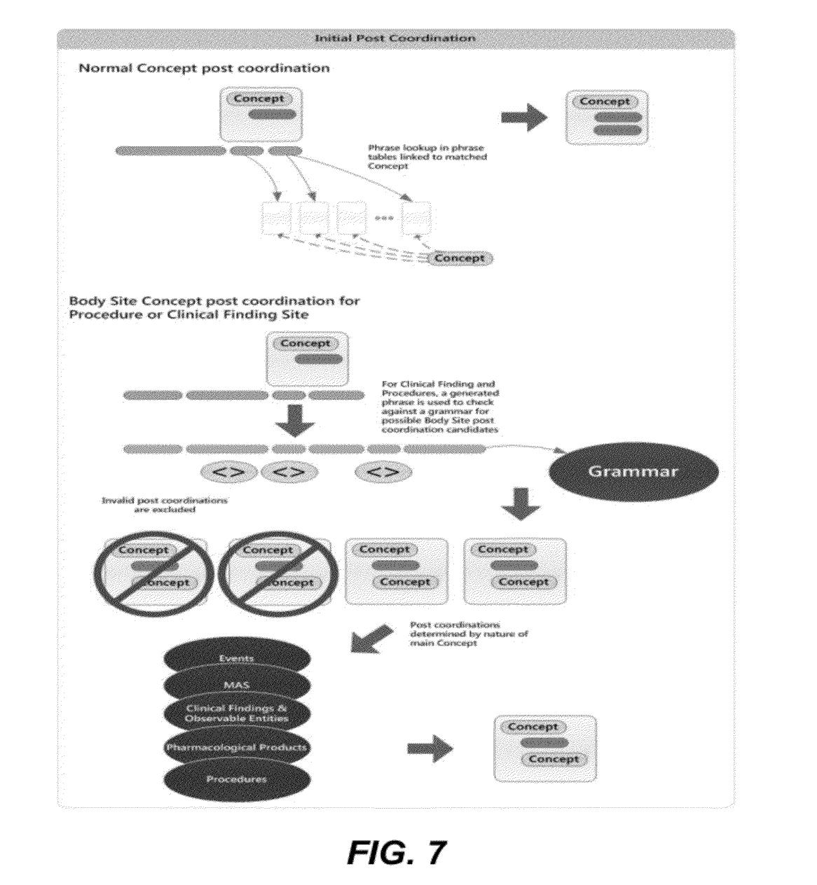

An example flow of the initial post-coordination activity is depicted in FIG. 7. To handle post-coordination by modification or qualification, the CLiX engine uses a specific phrase lookup to search within a window on either side of the target concept. The user vocabulary/phrase lookup tables, described in Section 3.1.2 above, provide the data which supports this style of post-coordination. These tables contain phrases that (1) can occur before the target concept, (2) can occur after the target concept, (3) should be avoided, or (4) limit phrases. For example, in the post-coordination of “Episode,” the table representing phrases that can occur prior to the target can include “first episode.” The table representing phrases that can occur after the target also includes “first episode.” Accordingly, a post-coordinated expression can be created that qualifies “asthma” to a “first episode.”

In our preferred embodiments, the algorithm employed for all modifier/qualifier style post-coordination is based on the technique described by the known NegEx algorithm. The NegEx algorithm identifies negatives in textual medical records. but with enhancements. For example, the NegEx algorithm operates on the principle of searching for one of many synonymous trigger phrases before or after a target and having pseudo phrases which effectively mean the qualifier should not be applied. The NegEx algorithm, however, prescribes the use of “regular expressions” to search the string. In contrast, here we use a suffix tree-based approach with a varying window size. The strings are represented in a suffix tree structure which provides very fast operations on the string including substring searching type operations. In addition, we provide separate tables and files describing the pre/post/pseudo terms, with synonymous phrases being cross referenced to the appropriate post-coordinating concept.

The CLiX engine follows a different approach for post-coordinating body structure concepts with procedure sites or clinical finding sites. Because body site concepts themselves will have already been identified in the concept matching phase, together with clinical findings or procedures, this data is processed by the CLiX engine to identify legitimate post-coordinated relationships. The engine uses a generated pseudo-phrase of concept types, sometimes together with the POS tags for prepositions, conjunctions and punctuation, to check against a grammar of possible relationships. Depending on the results of the matches to that grammar, post-coordinated relationships between one to many body sites and one to many findings or procedures are created. So, for example, when a body site is identified in an input string with a number of findings, the body site is linked to each finding. Post-coordinated relationships are checked against the prescribed rules during this phase to make sure they are legal refinements according to SNOMED CT. Any post-coordinated relationships which are not legal refinements are excluded.

In various embodiments, for each main concept found in the narrative input text, a different post-coordination processing model is chosen depending on specific criteria involving either the top level concept or a parent concept. Top level concepts are those concepts which sit at the top of a hierarchy of terms representing abstract concepts. The criteria for choosing include the following:
Concepts identified as Events can be processed to attempt post-coordination with Periods of Life.
Concepts identified as Morphologically Abnormal Structures can be processed to attempt post-coordination with a body site to create a new Clinical Finding. If no body site is found, the concept can be dropped. For example, “Angiokeratoma” matches a morphologically abnormal structure but, because no body site is present, it does not represent a legal expression and accordingly will be dropped. If this morphologically abnormal structure is linked to a finding site, e.g. “skin,” the valid statement “angiokeratoma of skin” is determined.
Clinical Findings and Observable Entities can be processed to attempt post-coordination with Body Site concepts found with any Clinical Finding as a Finding Site. Then post-coordination with Finding Values, Episodes, Courses, General Adjectival Modifiers and Periods of Life can be attempted.
Pharmacological products can be processed to attempt post-coordination with Administration Route, Administration Frequency, Procedure Value. An attempt can also be made if key phrases are present to create an Adverse Drug Reaction finding where the pharmacological product becomes the causative agent.
Procedures can be processed to first attempt post-coordination using the Body Site post-coordination mechanism. Second, post-coordination of Procedure Values can be attempted. Third, evaluation procedures can be post-coordinated with Finding values. Lastly, procedures can be post coordinated with Priorities, Time frames, Intents, Actions

### 3.3.2.2 Post-Coordination Filtering

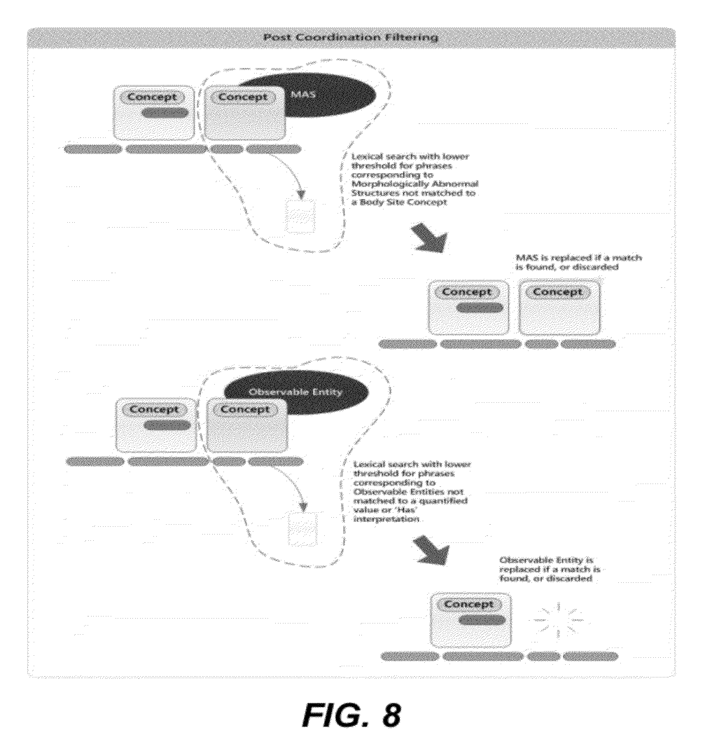

After the initial post-coordination activity, filtering is used to remove any post-coordinated expressions created which do not represent legal expressions according to the rules in the MRCM. An example flow of this filtering activity is depicted in FIG. 8.

A first type of filtering is performed to identify Morphologically Abnormal Structures (MAS) which have not been post-coordinated to a body site. In SNOMED CT, such MAS alone cannot be legal record entries. Therefore they are processed further using a lexical search. The lexical search attempts to find similar clinical findings using search thresholds which are relaxed. If a lexical search match is found this replaces the MAS, otherwise the MAS is discarded.

A second type of filtering is then performed to identify Observable Entities (a class of SNOMED CT concept representing measurable concepts such as those found in test results) that are not attached to either a quantified value or a post-coordination of type “has interpretation.” If such an Observable Entity is found, a further Clinical Finding search can be conducted with the same tokens used to match the Observable Entity with relaxed search thresholds. If this search for a similar Clinical Finding fails, the Observable Entity can be discarded.

### 3.3.2.3 Context Wrapper Post-Coordination

The SNOMED CT context wrapper is a standard series of SNOMED CT relationships and concepts that convey contextual information about a particular statement. For example, the context wrapper provides context as to whether a statement is about the patient or another person, such as a family member.

The context wrapper also provides a mechanism through which negation, certainty, severity, temporal context, and subject of record can all be specified. Negation provides confirmation of a statement as known present or known absent. For example, “no allergy to penicillin” is a statement of absence of an “allergy to penicillin” and means something entirely different from a statement of known presence of the allergy. Finding context within the context wrapper details whether the statement has been negated (“known absent”) or certainty (e.g., “probably present”) about a particular statement. The temporal context deals with the time aspect of the statement, thus allowing representation of past history versus a current problem.

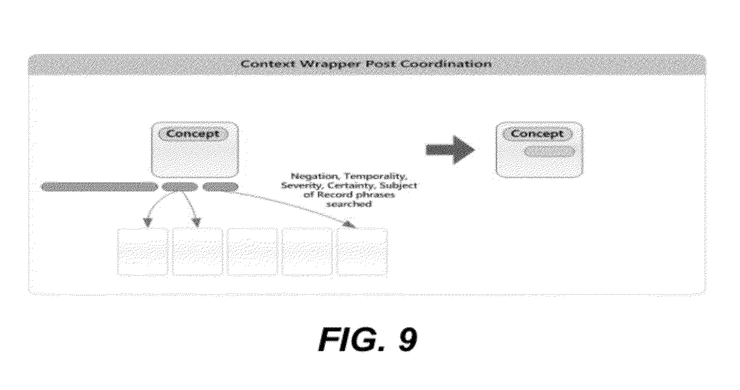

An example flow of the context wrapper post-coordination activity is depicted in FIG. 9. The following explains the processing performed by the CLiX engine to determine whether each of the above types of context wrapper elements should be applied to the output expression.

For negation, process each clinical finding to check:

whether the concept is negatable;

whether the term has already been negated within the SNOMED CT definition; and

whether the term contains a negation word.

If none of the above are true, then check for negation using the NegEx based mechanism (described in Section 3.3.2.1) of using pre/post phrases. If a phrase is present, the term is then negated by post-coordination.

For certainty, process each term in turn to check:

whether concept can have certainty set;

whether term already has certainty specified; and

whether term contains a certainty word.

If none of the above is true, check for certainty using the NegEx based mechanism described above in Section 3.3.2.1 using the certainty pre/post/pseudo file data. If the appropriate phrases are identified, post coordinate the certainty accordingly.

If a Finding or Procedure has a Finding Site or Procedure Site, or is lateralizable and not already lateralized, then search for pre/post phrase laterality phrases. If present, then add laterality concept post-coordination. The same approach is extended to Temporal Context and Subject of Record post-coordinations.

### 3.3.2.4 Soft Default Post-Coordination

In some cases, the clinical context of a particular concept can imply a post-coordination that may not otherwise be expressed within the body of the input text. Such a context can be supplied to the CLiX engine along with the input text to be translated. Accordingly, in the soft default post-coordination activity, a test can be made for concepts where the clinical context (e.g., a form section on family history) implies an axis modification (i.e., a change of meaning) When such concepts are identified, soft default post-coordination data for the concepts can be retrieved from the soft defaults data file (see section 3.1.2), and the concepts can be post-coordinated accordingly. For example, if the clinical context is “family history,” the subject of record for the concept being post-coordinated can be changed to “person in the family.”

### 3.3.3 Output Process

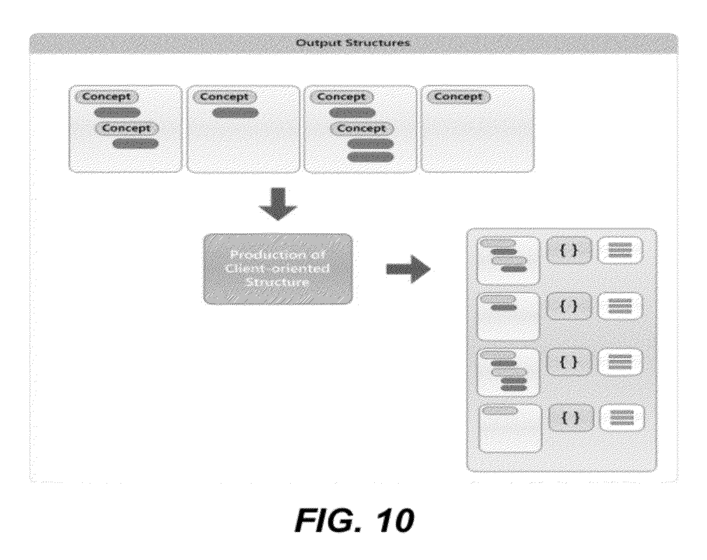

In various embodiments, the final process performed by the CLiX engine involves constructing output data structures that represent the encoded structural representation of the input narrative. FIG. 10 provides an example of this process. Prior to the output process, all of the data generated and used by the engine is stored in memory as proprietary data structures.

The CLiX engine provides output of a SNOMED CT expression in a choice of three different formats:

API “close to user” structure;

SNOMED CT compositional grammar form; and

Logical Record structure.

The API ‘close to user’ structure and the Logical Record structure incorporate information model statements that cannot be included in a SNOWMED CT Expression, such as values, dates, and the like. An example is “Height”=1.68 meters.” The 1.68 meters is an information model extension. Once created, these output data structures can be provided back to consumers of the engine, thereby concluding the processing cycle.

### 4. Example Narratives

To illustrate the concept and the power of the CLiX platform, we next provide examples of clinical narratives and how they are encoded by the techniques described herein. For each example, a piece of clinical narrative is provided and the output returned by the CLiXengine is shown. The screenshots represent exemplary user interfaces by clients 104 of FIG. 1.

In each screenshot, clinical narrative is entered on the right and the CLiX engine returns the corresponding SNOMED CT expression on the left in real-time. In these examples, recognized terms are underlined and highlighted in blue. The engine attempts to categorize the observations provided under familiar record headings.

### 4.1 Misspelling, Acronyms, Word Derivations, and Inflections

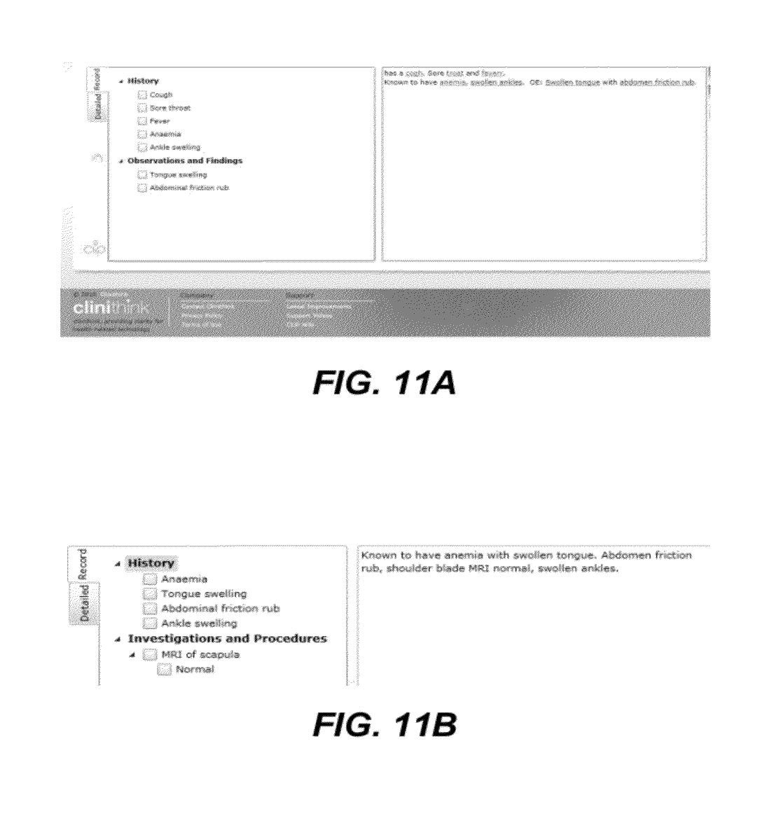

FIGS. 11A and 11B illustrate situations where the clinical narrative includes misspelled words—“cogh,” “troat,” “feverr”—as well as acronyms and word derivations such as “swollen tongue” versus “tongue swelling”. The CLiX engine recognizes these issues and provides an accurate structural representation of the input text.

### 4.2 Negation and Laterality

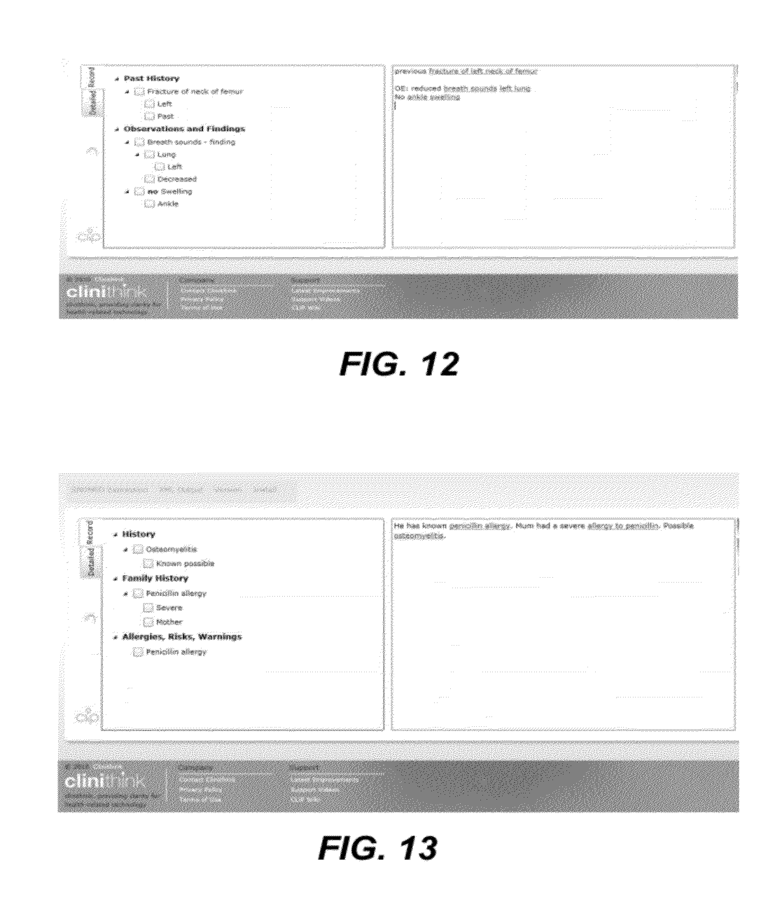

FIG. 12 illustrates a clinical narrative that includes various clinical concepts that are modified or qualified to form complex phrases with specific meaning—“fracture of left neck of femur”. In addition, the clinical narrative includes a negation of a concept—“no ankle swelling”. Using the post-coordination techniques described above, the CLiX engine interprets these statements and generates post-coordinated SNOMED CT expressions.

### 4.3 Severity, Certainty, Temporality, Subject

Clinicians often characterize observations with additional meaning related to severity (“severe cough,” “mild oedema”), certainty (“possible otitis media”), temporality (“previous myocardial infarction”) and subject (“mother has Huntingdon's chorea, no family history of atopy”). FIG. 13 illustrates how these characterizations can be recognized by the CLiX engine and encoded appropriately.

### 4.4 Finding Sites

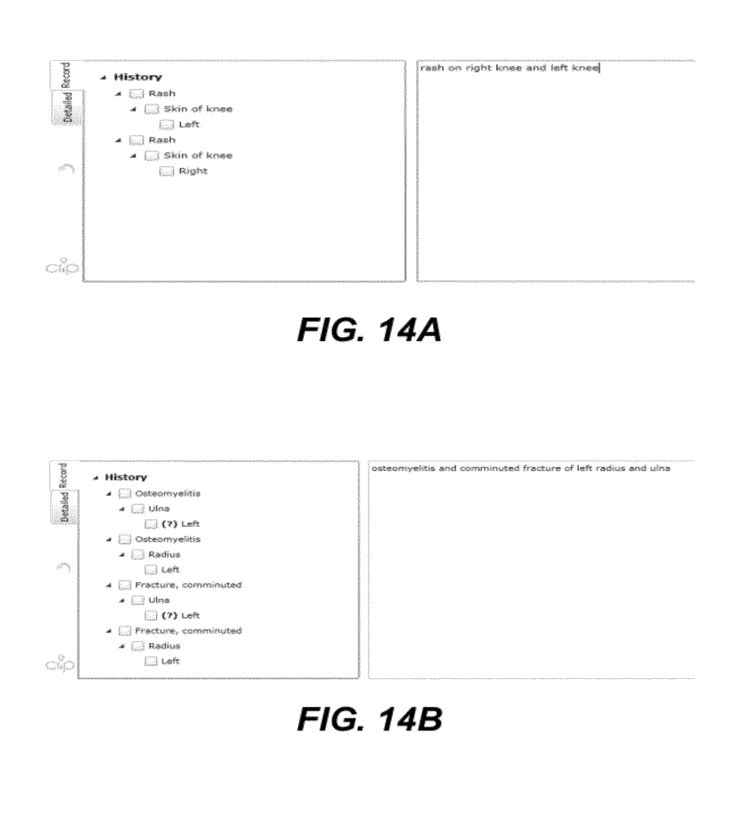

FIGS. 14A and 14B illustrate the capability of the CLiX engine to interpret and encode clinical narrative involving a single clinical finding, multiple implied finding sites with different laterality, and multiple clinical findings with multiple finding sites and multiple laterality.

### 4.5 Procedure Sites and Contexts

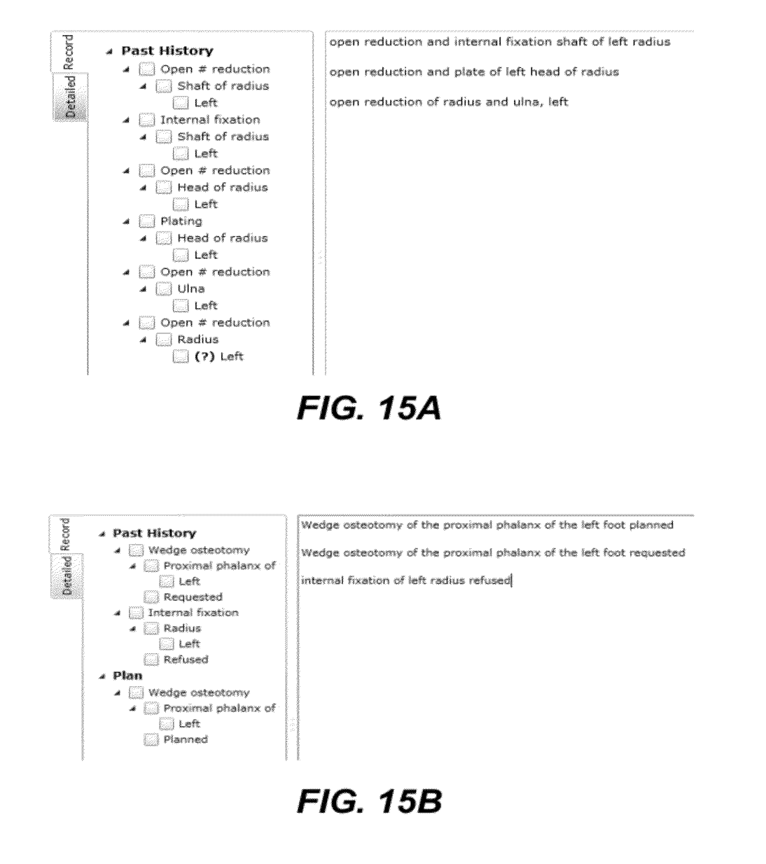

Like finding sites, procedure sites and procedure contexts can also be recognized by the CLiX engine. FIGS. 15A and 15B provide two examples that demonstrate how subtle variations in the free text statements are captured, giving rise to the structured equivalents.

### 4.6 Allergies, Adverse Reactions and Intolerances

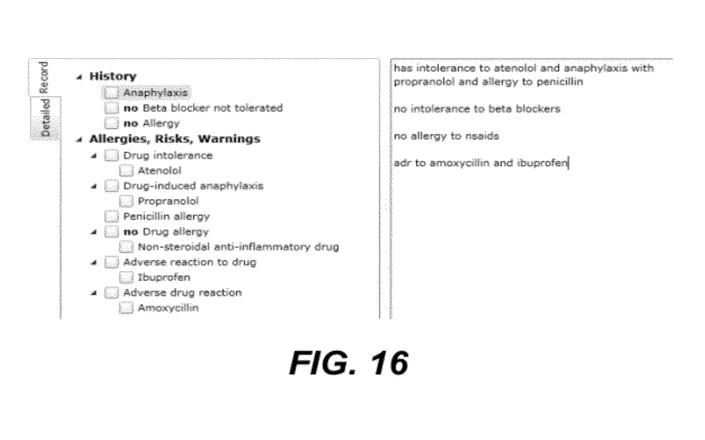

FIG. 16 illustrates clinical text including allergy and intolerance information. CLiX recognizes many forms of this type of statement, ensuring accurate and unambiguous correspondence with the original text.

### 4.7 Medications and Doses

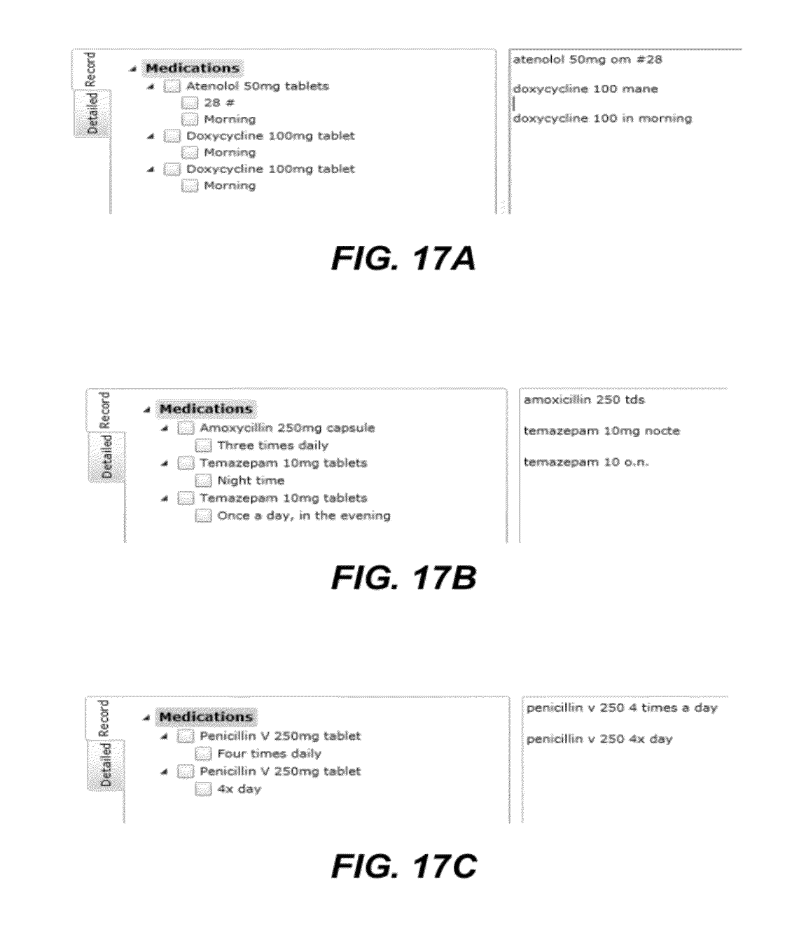

FIGS. 17A-17C illustrate various narratives that include medication and dose information, and how this information is encoded by the CLiX engine.

4.8 Finding Episodes, Clinical Finding Courses, and Events/Findings with Period of Life

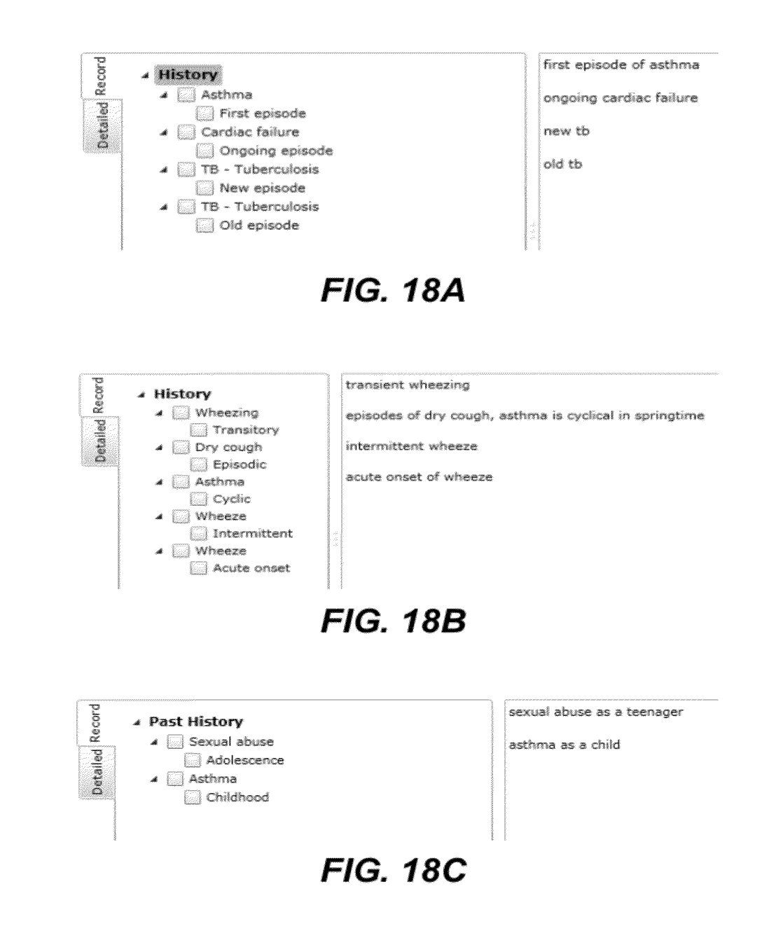

FIG. 18A illustrates how the CLiX engine can identify and encode statements pertaining to episode chronology, such as “first episode,” “ongoing,” and the like. FIG. 18B illustrates the recognition of clinical finding courses. And FIG. 18C illustrates the recognition of period of life events and findings.

### 4.9 Combinations

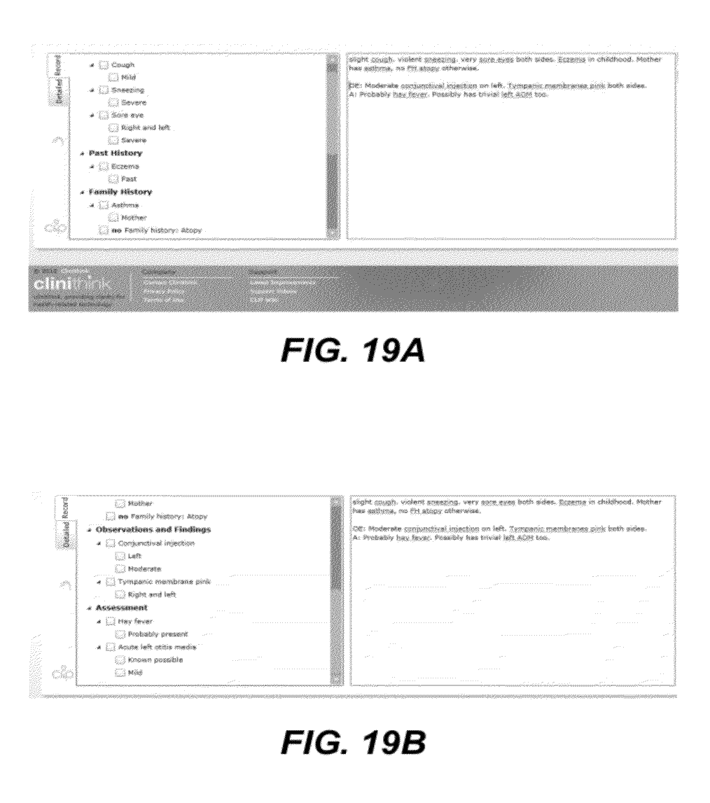

FIGS. 19A and 19B illustrate a clinical narrative that includes combinations of all of the above examples. These types of complex combinations frequently occur in normal clinical narrative and can be handled appropriately by the CLiX engine.

### 5. Additional Features

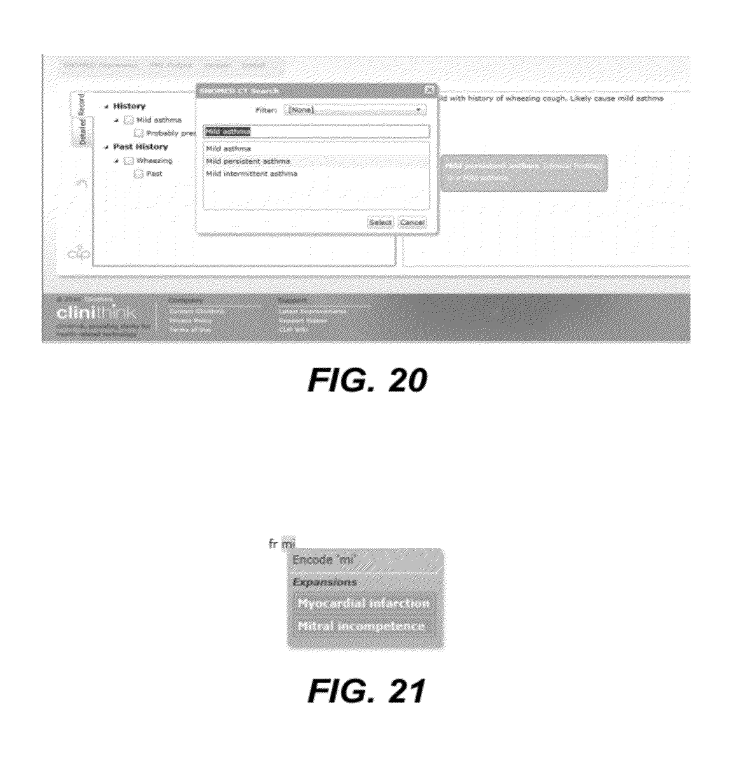

As discussed with respect to FIG. 1, the CLiX platform is also able to provide additional services beyond narrative translation that provide assist in a healthcare information technology environment. Users may wish to navigate directly to a SNOMED CT term using a traditional means of progressive search much like that of modern search engines. The CLiX platform can provide both a client-side feature and server-side API which support progressive searching even with partial terms. FIG. 20 illustrates this.

The CLiX platform also can provide spelling suggestions and acronym expansions as a user is entering text into the system. FIG. 21 illustrates a pop-up box that provides an alternative to “Myocardial infarction” based on the encoding of its abbreviation “mi.” While providing a convenient short-cut to entering a correct spelling or full expansion of a lengthy term, this is control feature allows the user to ensure that the intended meaning is captured.

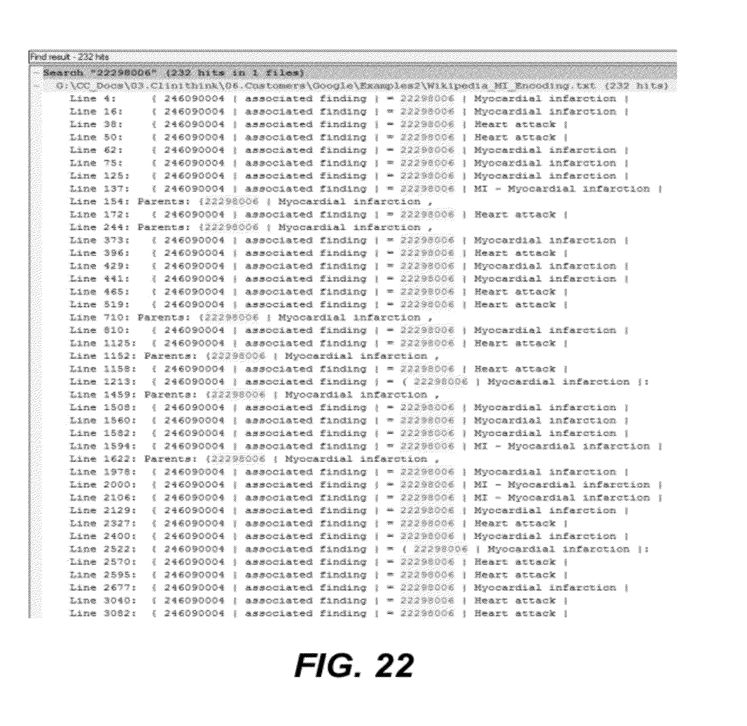

CLiX technology also enables an indexing mechanism to index healthcare content of any kind FIG. 22 is a screenshot of a text editor that illustrates the total number of matches (232) for the SNOMED CT concept 22298006 within the indexing results produced by the CLiX engine for sample text from Wikipedia against the phrase “myocardial infarction”. The screenshot shows that this concept is a match to three discrete variations of the term within the text itself: “MI,” “Myocardial Infarction” and “Heart Attack.”

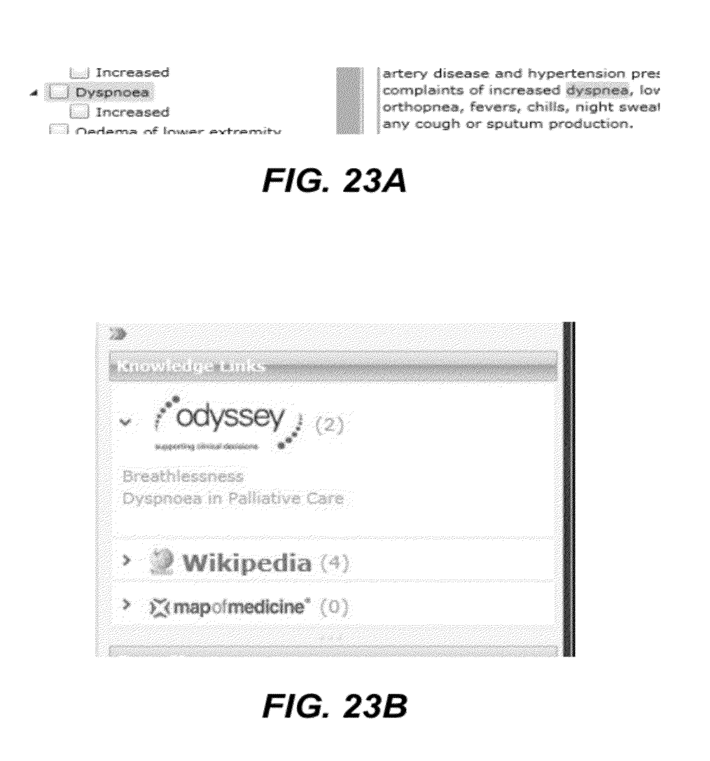

An extension to the page indexing described above is the provision of “knowledge links” to consumer applications. This enables concept-centric browsing of pertinent web content, driven by the encoded item or text currently “active.” In FIG. 23A, the text “dyspnoea” has been selected by the user in a simple “point and click” action. The result is to highlight the corresponding encoded concept on the far left of the image. Simultaneously, knowledge links for the selected term are displayed in the “Knowledge Links” panel on the far right of the image showing two entries from the Patient UK resource and four from Wikipedia (see FIG. 23B). A single click on one of these resource links can open a new web browser window displaying the specific content.

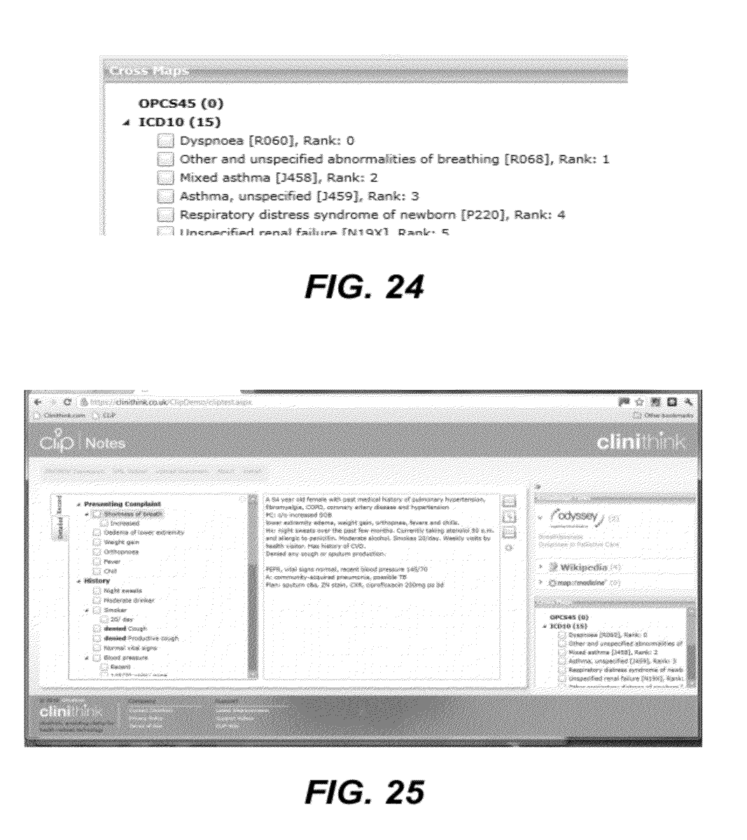

In a similar vein, cross-mapped concept information from other systems can be viewed by clicking on a concept. The cross-map matches can be made available, e.g., via CLiX web service APIs and may be displayed alongside the original text and encoded output. FIG. 24 illustrates a user interface showing fifteen cross-maps to the ICD10 system for the SNOMED CT concept “dyspnoea.” Cross-maps can also be provided to other systems such as OPCS 4.5.

The combination of the foregoing features provide a complete user experience that enables clinical users to access encoded information in a variety of different ways. FIG. 25 is a screenshot of a sample client user interface that incorporates these features.

### 6. Output

As discussed in section 3.3.3, the CLiX engine can provide output in a number of different formats including SNOMED CT grammar and XML, depending on how it is being used. The output also can be provided in a format consistent with HL7v3 and standard record models, such as EN13606 and the NHS Logical Record Architecture.

Below is CLiX output a SNOMED CT grammar statement. This output represents some of the most commonly required data in a correctly-formed SNOMED CT statement.

Type: FINDING_OBSERVATION_ELEMENT
obs_time: UNSPECIFIED
meaning: ( 243796009 | situation with explicit context |:

{ 246090004 | associated finding | = 22298006 |
MI - Myocardial infarction

, 408729009 | finding context |= 410515003 | known present
, 408731000 | temporal context |= 410512000 | current or specified
, 408732007 | subject relationship context |= 410604004 |
subject of record

})

Parents: {128599005 | Structural disorder of heart ,
123397009 | Injury of anatomical site ,
57809008 | Myocardial disease ,
}

### 7. Use Cases

This invention provides significant value to various different market segments. In the electronic health records market, CLiX technology facilitates real time data entry, data views, SNOMED CT and ICD coding. This in turn facilitates links to knowledge resources and decision support. As well as real-time support, integration with 3rd party analytics platforms enables the same powerful interpretation capability to be leveraged against semi-structured data for the purposes of aggregate analysis. Finally, as illustrated above, CLiX improves the accuracy of search returns and helping to broker more accurate links between health information consumers and providers on the Web.

Across the different market segments, integration of CLiX technology with third party products helps quality and efficiency in healthcare through:
Improved physician uptake of EHR/EPR solutions
Improved utilization of physician time
Improved decision support delivered at the point of care and decision making leading to improved outcomes and efficiency
Improved efficiency and accuracy in coding activity
More precise means of performance managing healthcare providers through comparable outcome data
Improved aggregate analysis facilitating research and audit

### 8. System Environment

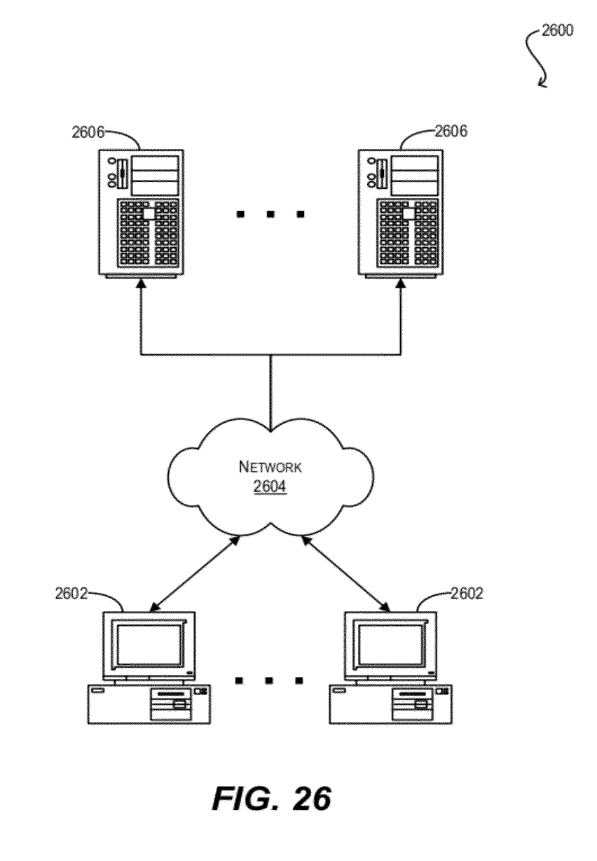

FIG. 26 is a simplified block diagram illustrating a typical system environment 2600 used for deploying the CLiX platform. System environment 2600 includes client computing devices 2602 configured to execute a client application such as a web browser, a Windows application, or similar interface. The client computing devices 2602 run clients 104 of FIG. 1 and are operated users to invoke and interact with CLiX services.

Client computing devices 2602 can be general purpose personal computers (e.g., personal computers or laptop computers running Microsoft Windows or Apple Macintosh operating systems, cell phones or PDAs with an Internet, e-mail, SMS, Blackberry, or other communication protocol enabled), or workstation computers running commercially-available UNIX or UNIX-like operating systems, including without limitation the variety of GNU/Linux operating systems. Alternatively, client computing devices 2602 can be other electronic device capable of communicating over a network, such as network 2604.

The system environment 2600 will usually include a network 2604. Network 2604 can be any type of network that supports data communications using a network protocol, such as TCP/IP, SNA, IPX, or AppleTalk. Network 2604 can be a local area network such as an Ethernet network, a Token-Ring network, a wide-area network; a virtual network, including a virtual private network; the Internet; an intranet; an extranet; a public switched telephone network, an infra-red network, a wireless network, etc.

System environment 2600 will also usually include servers 2606 which can be general purpose computers, specialized server computers, including PC servers, UNIX servers, mid-range servers, mainframe computers, rack-mounted servers, server farms, server clusters, or any other appropriate arrangement or combination. Servers 2606 can run an operating system including any of those discussed above, as well as any commercially available server operating system. Servers 2606 can also run any of a variety of server applications and/or mid-tier applications, including web servers, FTP servers, CGI servers, Java virtual machines, and the like. The servers 2606 are configured to run instances of the CLiX server side platform, e.g. server instance 102 shown in FIG. 1.

Although not shown, system environment 2600 can also include databases configured to store information used by computers 2602 and/or 2606. In one set of embodiments, these databases store information maintained by data stores 122-126 of FIG. 1. The databases can reside in a storage-area network.

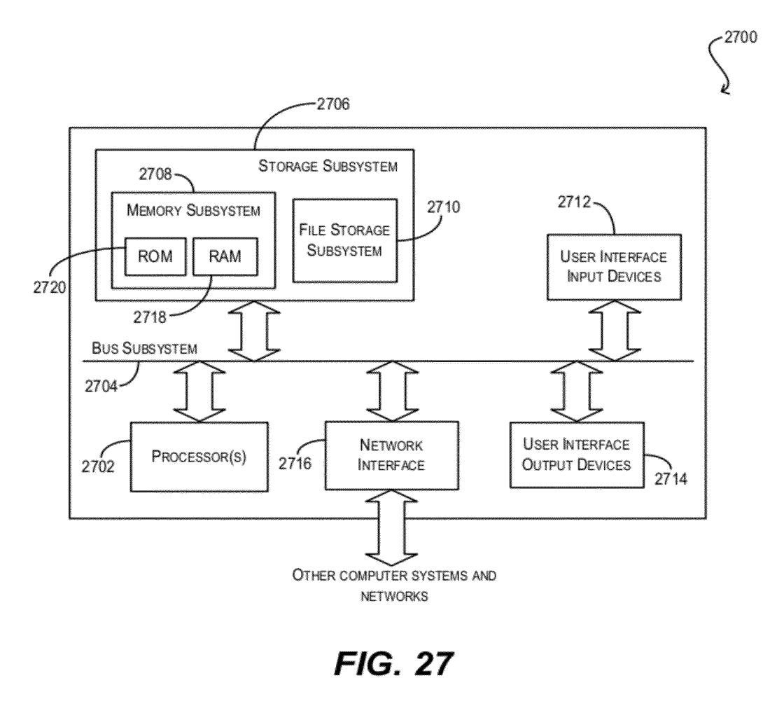

FIG. 27 is a simplified block diagram of a computer system 2700 according to an embodiment of the present invention. In one set of embodiments, computer system 2700 can be used to implement any of computers 2602 and 2606 described with respect to system environment 2600. As shown in FIG. 27, computer system 2700 includes processors 2702 that communicate with a number of peripheral subsystems via a bus subsystem 2704. These peripheral subsystems include a storage subsystem 2706 having a memory subsystem 2708, a file storage subsystem 2710, user interface input devices 2712, user interface output devices 2714, and a network interface subsystem 2716.

Bus subsystem 2704 provide a mechanism for enabling the various components and subsystems of computer system 2700 to communicate with each other. Although bus subsystem 2704 is shown schematically as a single bus, multiple busses can be used. Network interface subsystem 2716 serves as an interface for receiving data from and transmitting data to other systems or networks.

User interface input devices 2712 include a keyboard, pointing devices such as a mouse, trackball, touchpad, or graphics tablet, a scanner, a barcode scanner, a touch screen incorporated into the display, audio input devices such as voice recognition systems, microphones, and other types of input devices. In general, we use input device to refer to any device or mechanism for inputting information to computer system 2700.

User interface output devices 2714 include a display, a printer, a fax machine, or non-visual displays such as audio output devices. The display subsystem can be a cathode ray tube, a flat-panel device such as a liquid crystal display, or a projection device. We use output device to refer to any device for conveying information from computer system 2700.

Storage subsystem 2706 provides a computer-readable storage medium for storing basic programming and data constructs that provide the functionality of the present invention. Software, that is programs, code modules, and instructions, that when executed by a processor provide the functionality of the present invention can be stored in storage subsystem 2706. This software is executed by processor(s) 2702. Storage subsystem 2706 also provides a repository for storing data used in the present invention. Storage subsystem 2706 can be formed from memory subsystem 2708 and file/disk storage subsystem 2710.

Memory subsystem 2708 includes a main random access memory (DRAM) 2718 for storage of instructions and data during program execution and a read only memory (ROM) 2720 in which fixed instructions are stored. File storage subsystem 2710 provides a non-transitory persistent storage for program and data files. This system can be provided by a hard disk drive, a floppy disk drive and associated removable media, an optical drive, removable media cartridges, USB memory sticks, as well as other storage media.

Although specific embodiments of the invention have been described, various modifications, alterations, alternative constructions, and equivalents are also encompassed within the scope of the invention. For example, embodiments of the present invention are not restricted to operation within specific environments or contexts, but are free to operate within a plurality of environments and contexts. Further, although embodiments of the present invention have been described with respect to certain flow diagrams and steps, it should be apparent to those skilled in the art that the scope of the present invention is not limited to the described diagrams or steps.

Still further, while embodiments of the present invention have been described using a particular combination of hardware and software, it should be recognized that other combinations of hardware and software are also within the scope of the present invention. The specification and drawings are, accordingly, to be regarded in an illustrative rather than a restrictive sense. It will be evident that additions, subtractions, deletions, and other modifications and changes may be made without departing from the broader spirit and scope of the invention.

What is claimed is:

1. A method comprising:
receiving a clinical narrative by a computer system;
using the computer system translating the clinical narrative into a structural representation, wherein:
the structural representation is encoded according to a clinical reference terminology, and
the structural representation corresponds to a valid post-coordinated expression of the clinical reference terminology; and
outputting the structural representation from the computer system.

2. The method of claim 1 wherein the clinical reference terminology is SNOMED CT.

3. The method of claim 1 wherein the step of translating is performed in substantially real-time.

4. The method of claim 1 wherein the clinical narrative includes:
a reference to a first concept of the clinical reference terminology;
a subsequent reference to a second concept of the clinical reference terminology that modifies the first concept; and
wherein a post-coordinated expression includes a valid post-coordination relationship between the first concept and the second concept.

5. The method of claim 4 wherein the second concept conforms to a legitimate relationship to the first concept that may be expressed by the clinical reference terminology.

6. The method of claim 5 wherein the first concept is a clinical finding or procedure and the second concept is a body site.

7. The method of claim 5 wherein the first concept is an event and the second concept is a period of life.

8. The method of claim 5 wherein the first concept is a body site and wherein the second concept is a laterality.

9. The method of claim 5 wherein the second concept represents one of certainty, temporality, subject, and negation.

10. The method of claim 1 wherein the step of receiving the clinical narrative comprises receiving a clinical context that applies to the clinical narrative, and wherein the step of translating the clinical narrative is based, at least in part, on the clinical context.

11. The method of claim 1 wherein the step of translating comprises:
preparing first data pertaining to the clinical reference terminology;
preparing second data including language processing metadata;
importing the first data and the second data as memory-mapped files; and wherein the step of translating the clinical narrative into the structural representation uses the memory-mapped files.

12. A computer readable storage medium having stored thereon non-transitory program code executable by a processor, the program code comprising:
code that causes the processor to receive a clinical narrative;
code that causes the processor to translate the clinical narrative into a structural representation wherein:
the structural representation is encoded according to a clinical reference terminology, and
the structural representation corresponds to a valid post-coordinated expression of the clinical reference terminology; and
code that causes the computer system to output the structural representation.

13. A system comprising a processor and a memory configured to:
receive a clinical narrative;
translate the clinical narrative into a structural representation wherein:
the structural representation is encoded according to a clinical reference terminology, and
the structural representation corresponds to a valid post-coordinated expression of the clinical reference terminology; and
output the structural representation.

14. A method comprising:
using a computer system identifying a concept in a clinical narrative, the concept being defined in a clinical reference terminology;
with the computer system identifying a first window of terms before the concept in the clinical narrative and identifying a second window of terms after the concept in the clinical narrative; and
using at least one lookup table, determining if the first window and the second window includes any terms that can validly be post-coordinated with the concept according to the clinical reference terminology.

15. The method of claim 14 further comprising a step of determining, by the computer system based on at least one lookup table, whether the first window or the second window includes any terms that indicate the concept should not be post-coordinated.

16. The method of claim 15 wherein the at least one lookup table includes at least one lookup table for each type of post-coordination supported by the clinical reference terminology.

17. The method of claim 14 further comprising:
determining a type of the concept; and
based on the type of the concept, applying a model for processing post-coordination of the concept.

18. The method of claim 14 further comprising a step of filtering, based on a description logic defined for the clinical reference terminology, concepts that have not be validly post-coordinated.

19. The method of claim 18 wherein the concepts include a morphologically abnormal structure that has not been validly post-coordinated with a body site.
